(19) United States
(12) Patent Application Publication
(10) Pub. No.: US 2005/0168875 A1
(43) Pub. Date: Aug. 4, 2005

(54) Rotary magnetic head drum apparatus

(75) Inventors: Shinji Okada, Hitachinaka (JP); Kuniaki Hirayama, Hitachinaka (JP); Yoshio Uemura, Hitachinaka (JP); Hidekazu Takeda, Hiratsuka (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/896,098

(22) Filed: Jul. 20, 2004

(30) Foreign Application Priority Data
Feb. 3, 2004 (JP) 2004-026200

(51) Int. Cl. G11B 5/52

(52) U.S. Cl. 360/271.6

(57) ABSTRACT

An object of the present invention is to provide a center drum rotating type of rotary magnetic head drum apparatus, which improves an accuracy of alignment of an upper fixed drum, and easily executes a fine adjustment. In correspondence to the object mentioned above, a hole fitted to a shaft is provided at a position coaxial with an outer periphery of an upper fixed drum in an end surface portion of an upper portion of the upper fixed drum, the shaft is inserted to the hole, a slope of the end surface portion of the upper portion of the upper fixed drum is adjusted while being fixed by a male screw and a locking screw, and a fine adjustment is executed for aligning the upper fixed drum. In particular, an outer periphery of the upper fixed drum in an input side of the tape is slightly moved backward from an outer periphery of the upper fixed drum in an output side of the tape, with respect to an outer periphery of the lower fixed drum.

### INCORPORATION BY REFERENCE

The present application claims priority from Japanese application JP2004-026200 filed on Feb. 3, 2004, the content of which is hereby incorporated by reference into this application.

### BACKGROUND OF THE INVENTION

1. Field of the Invention

The present invention relates to a helical scan type magnetic recording and reproducing apparatus for recording and reproducing a signal on a magnetic tape by using a rotating magnetic head, and more particularly to a middle rotary drum type rotary magnetic head drum apparatus.

2. Description of the Related Art

On the basis of a digitization and a broad band of the recording signal in recent years, a dramatic improvement is requested for a recording rate. In order to achieve a high recording rate in the helical scan system, there is employed a method of increasing a rotation speed of a drum, a method of shortening a wavelength of the recording signal or a method of making a recording channel multi channel. In any of the methods, it is necessary to more stably keep a contact between the tape and the head, and it is important how to control an air (an air film) flowing around the rotating drum. In the recent VTR, particularly VTR for broadcasting service, in order to attach importance to a compatible reliability and a traveling reliability of the tape under various environments, there is frequently employed an upper fixed center rotating drum system in which an upper fixed drum is arranged on the same axis of a lower fixed drum provided with a lead for guiding a tape travel, a rotating center drum is arranged in a portion pinched by both the fixed drums, and a magnetic head is mounted to the center drum.

However, generally, in the upper fixed center rotating system, an eccentric error of the upper fixed drum tends to be generated with respect to the lower fixed drum and the center rotating drum. The contact between the magnetic head and the magnetic head becomes incomplete even by the eccentric error of about 0.005 mm, a recording and reproducing signal level is lowered, and an envelope (an envelope curve) of an output waveform is not flat. Further, a dimensional accuracy of the magnetic pattern recorded on the magnetic tape is deteriorated, thereby deteriorating a compatibility. In order to solve the problems mentioned above, it is necessary to fine adjust an alignment of the upper fixed drum.

As a method of adjusting the upper fixed drum in the upper fixed center rotating drum system, for example, there is a technique disclosed in JP-A-7-201024. In JP-A-7-201024, for the purpose of reducing an error in a rotation locus of the head, there is provided an adjuster for adjusting a horizontal level and a vertical level of a rotational axis holding member in the upper fixed drum.

Further, since an output side tape tension is increased by a friction with respect to a magnetic tape input side tape tension at a time of adjusting the drum, there are problems that a tape tension is not uniform, and the contact between the magnetic tape and the magnetic head is not stable.

Further, in JP-A-7-201024 mentioned above, there is disclosed a technique in which two rotational shafts are provided for the upper drum and the lower drum, and the center drum mounting the magnetic head thereto is attached to the rotational shaft in the side of the upper drum. It is a structure in which the rotation locus of the magnetic head is adjusted by the adjuster, and the upper drum and the center drum are integrally movable at that time. In other words, as a result of adjusting the upper drum, a scanning position of the magnetic head is changed. Accordingly, this structure can not achieve a solution for stably keeping the contact between the tape and the head. Further, the adjuster disclosed in JP-A-7-201024 is complex in structure, and a great number of parts are required.

### BRIEF SUMMARY OF THE INVENTION

As mentioned above, the prior art does not take into consideration an accuracy of alignment and an adjustment of the upper fixed drum for more stably keeping the contact between the magnetic head and the magnetic tape. An object of the present invention is to improve an accuracy of alignment in the upper fixed drum, and to provide a structure which can easily achieve a fine adjustment. Accordingly, an object of the present invention is to provide a rotary magnetic head drum apparatus and a magnetic recording and reproducing apparatus which can obtain an improved output signal.

Taking the objects mentioned above into consideration, in accordance with the present invention, there is provided a rotary magnetic head drum apparatus in which a lower fixed drum, an upper fixed drum and a center rotating drum pinched therebetween and mounting a magnetic head thereon are coaxially mounted to a fixed shaft, wherein an adjuster for adjusting an attitude of the upper fixed drum with respect to the lower fixed drum and the center rotating drum is provided in an end surface portion of an upper portion in the upper fixed drum.

The present invention is structured such that a preload metal fitting is fixed to a free end side of a fixed shaft, a hole fitting to the shaft is provided at a position coaxial with an outer periphery of the upper fixed drum in the end surface portion of the upper portion in the upper fixed drum, the shaft is inserted to the hole, and the upper fixed drum is mounted and fixed to a free end side of the preload metal fitting.

Further, the structure is made such that a female thread is provided in the preload metal fitting, a screw insertion hole is provided in the upper surface portion of the upper portion in the upper fixed drum, the upper fixed drum is mounted to a free end side (an opposite side to a bearing side) of the preload metal fitting, and the upper fixed drum is fixed to the preload metal fitting by a male screw at a predetermined fastening torque. Further, the structure is made such that the upper fixed drum is fixed to the preload metal fitting by a screw passing a spring washer therethrough at a predetermined fastening torque.

Further, the inventors of the present invention have found that an ultra micro displacement is generated in the fastened object on the basis of a change of a fastening torque at a time of fastening by screw, and the ultra micro displacement is approximately equal to an amount of adjustment required for aligning the upper fixed drum. Further, the inventors have found that the displacement corresponds to a slope displacement of the upper fixed drum, however, is effective for the alignment adjusting. Accordingly, the slope of the upper fixed drum is finely adjusted by providing the female thread penetrating through the end surface portion of the upper portion in the upper fixed drum apart from the screw insertion hole in the end surface portion of the upper portion of the upper fixed drum, mounting the upper fixed drum to the free end side of the preload metal fitting, fine adjusting the slope of the upper fixed drum while fastening the male thread, and screwing the locking screw to the female thread in the end surface portion of the upper portion in the upper fixed drum.

Further, the upper fixed drum is aligned by fine adjusting the incline in one direction of the upper fixed drum by increasing and reducing the fastening torque to the preload metal fitting by the male screw passing the spring washer therethrough so as to fix, screwing the locking screw to the penetrating female thread, and fine adjusting the slope of another direction of the upper fixed drum while increasing or reducing the screwing amount.

Further, since the position of adjustment by the locking screw can be optionally selected, the upper fixed drum is aligned by providing the penetrating female thread at an angle phase position matching to a position to be controlled a contact between the tape and the head, screwing the locking screw, and fine adjusting the upper fixed drum while increasing or reducing the screwing amount.

Further, in the case that a side to which the magnetic tape moves forward to the rotary magnetic head drum apparatus is set to an input side, and an side to which the magnetic tape moves out is set to an output side, an outer periphery of a lower end portion of the upper fixed drum in the input side is slightly retracted from an outer periphery of the lower fixed drum than the outer periphery of the lower end portion of the upper fixed drum in the output side.

### BRIEF DESCRIPTION OF SEVERAL VIEWS OF THE DRAWING

These and other object, features and advantages of the present invention will become more readily apparent from the following detailed description when taken in conjunction with the accompanying drawing wherein:

FIG. 1 is a cross sectional view of a first embodiment of a rotary magnetic head drum apparatus in accordance with the present invention;

FIG. 2 is a plan view of the first embodiment of the rotary magnetic head drum apparatus in accordance with the present invention;

FIG. 3 is a cross sectional view of the first embodiment of the rotary magnetic head drum apparatus in accordance with the present invention;

FIG. 4 is a view for explaining an adjusting operation of the first embodiment of the rotary magnetic head drum apparatus in accordance with the present invention;

FIG. 5 is a cross sectional view of a second embodiment of a rotary magnetic head drum apparatus in accordance with the present invention;

FIG. 6 is a view for explaining an adjusting operation of the second embodiment of the rotary magnetic head drum apparatus in accordance with the present invention; and

FIG. 7 is a cross sectional view of a third embodiment of a rotary magnetic-head drum apparatus in accordance with the present invention.

### DETAILED DESCRIPTION OF THE INVENTION

In accordance with the present invention, a micro alignment adjusting mechanism of 0.001 mm unit is provided by a rotary magnetic head drum apparatus having a structure which can easily perform a work from one direction by using a general purpose screw. In the following embodiment, a drum diameter and a rotational speed can be appropriately set respectively within a range between 20 mm and 100 mm and a range between 1500 rpm and 1000 rpm in correspondence to the following embodiment.

### Embodiment 1

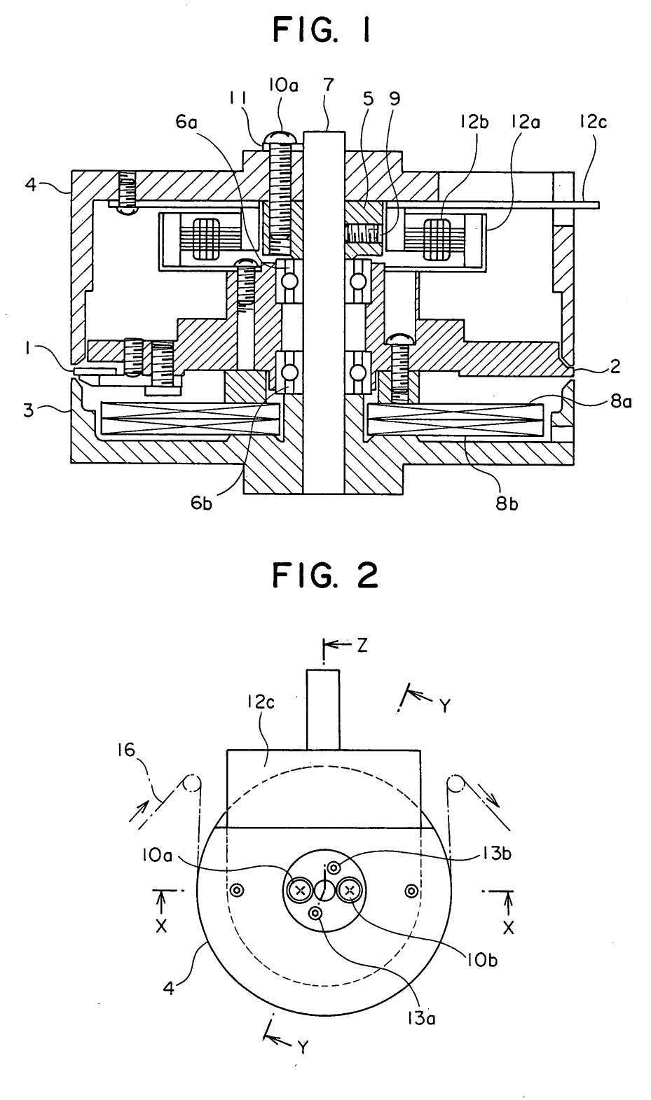

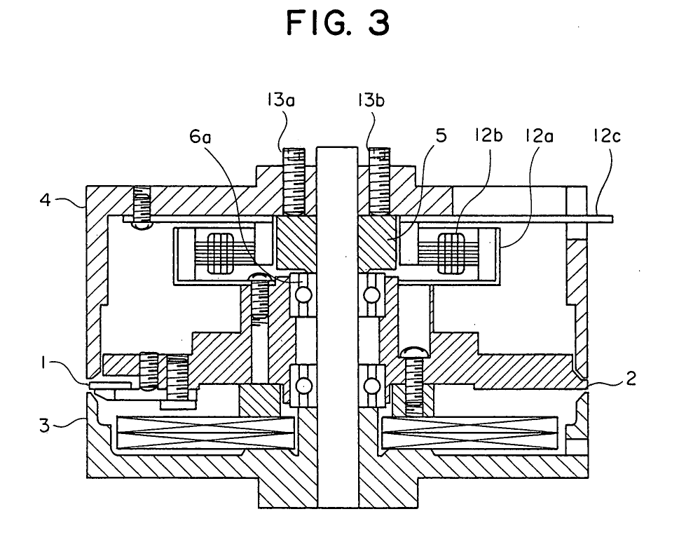

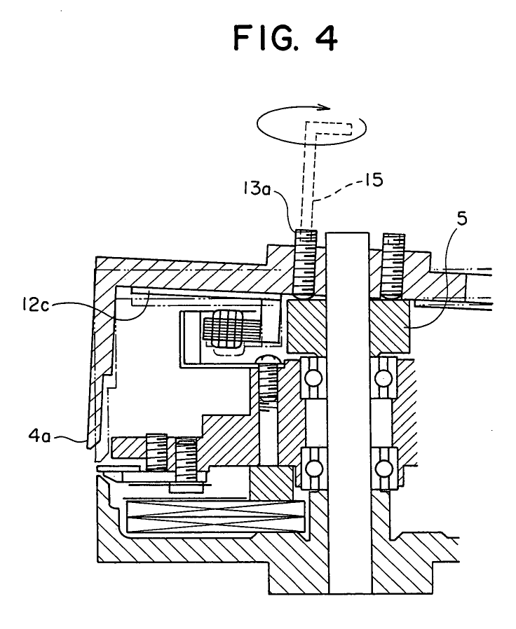

FIGS. 1 to 4 show a first embodiment of a rotary magnetic head drum apparatus in accordance with the present invention. FIG. 2 is a plan view of the present embodiment, FIG. 1 is a cross sectional view along a line X-Z and FIG. 3 is a cross sectional view along a line Y-Y in FIG. 2. FIG. 4 is a cross sectional view for explaining a fine adjusting operation.

In FIGS. 1 and 2, a shaft 7 is pressure inserted to a lower fixed drum 3. Reference numeral 2 denotes a center rotating drum. The center rotating drum mounts a magnetic head 1 thereon, and is controlled at a predetermined rotational speed so as to rotate around the shaft 7. Reference symbols 6a and 6b denote a ball bearing. A preload metal fitting 5 is fixed to the shaft 7 by a locking screw 9, and applies a preload to the ball bearings 6a and 6b. Reference symbol 12a denotes a motor rotor. The motor rotor 12a is mounted to an upper end surface portion of the center rotating drum. Reference symbol 12b denotes a motor coil, and reference symbol 12c denotes a motor stator. The upper fixed drum 4 is fitted to the shaft 7 in an end surface portion of an upper portion, and is fastened to the preload metal fitting 5 by male screws 10a and 10b passing spring washers 11 therethrough.

As mentioned above, since the rotary magnetic head drum apparatus in accordance with the present embodiment is structured such that a hole fitting to the shaft is provided at a position coaxial with an outer periphery of the upper fixed drum in the end surface portion of the upper portion of the upper fixed drum, the shaft is passed through the hole, and the upper fixed drum is mounted and fixed to the preload metal fitting, it is possible to improve an accuracy of alignment.

Next, a description will be given of a method of adjusting the upper fixed drum. A slope in one direction (X-X direction) of the upper fixed drum can be fine adjusted by increasing or reducing a fastening torque at a time of fastening the male screws 10a and 10b mounted to the upper fixed drum.

Further, in FIGS. 2 and 3, a penetrating female thread 14 is provided in a Y-Y direction of the upper fixed drum 4, and locking screws 13a and 13b are screwed thereinto. At this time, a slope in another direction (Y-Y direction) of the upper fixed drum can be fine adjusted by increasing or reducing a screwing amount. In accordance with the present embodiment, since the slope in two directions (the X-X direction and the Y-Y direction) can be fine adjusted by adjusting the male screws 10a and 10b and the locking screws 13a and 13b, it is possible to achieve an alignment adjusting all around the periphery. It is possible to control displacement (error) in an outer periphery of a lower end portion of the upper fixed drum within 0.005 mm after the fine adjustment.

FIG. 4 shows with exaggeration a motion of the upper fixed drum 4 in the case of increasing the screwing amount of the locking screw 13a, in which a state before adjustment is shown by a two-dot chain line, and a position of the upper fixed drum after adjustment is shown by reference symbol 4a. In this case, the element which is movable by the adjustment is only the upper fixed drum, and the positions of the center rotating drum 2 and the magnetic head 1 mounted thereon are not changed.

As mentioned above, the upper fixed drum generates an ultra micro slope change by increasing or reducing the fastening torque of the male screw in the end surface portion of the upper portion of the upper fixed drum and the screwing amount of the locking screw, thereby improving the error (the displacement) of the element in the outer peripheral direction. The ultra micro slope change corresponds to a suitable amount for executing the alignment adjusting.

Since the adjusting portion is put together in the upper surface portion of the rotary magnet head drum apparatus, and is operated by screwing from the upper side to the lower side, an adjusting work is easily executed. Further, since the preload metal fitting mounting the upper fixed drum thereon is a part which has been conventionally provided in the ball bearing for applying the preload, only the male screw and the locking screw are required as additional required parts, and no cost increase is caused.

### Embodiment 2

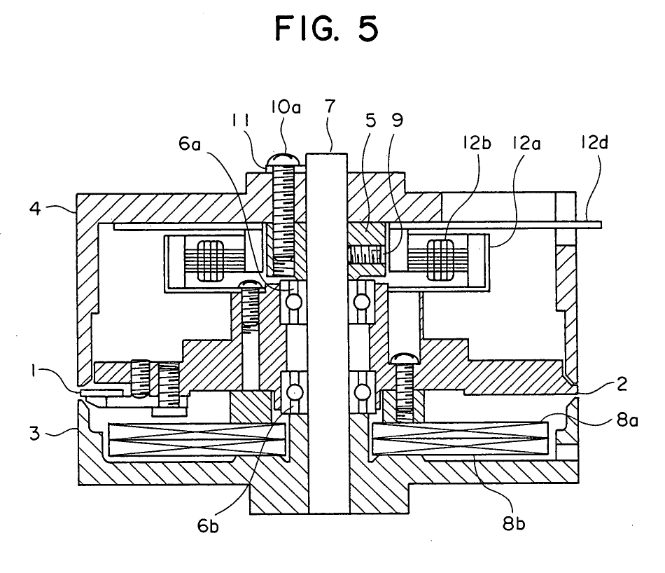

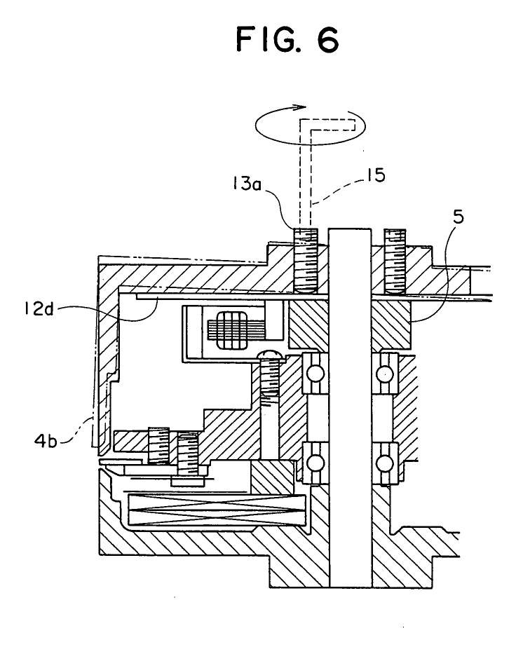

FIGS. 5 and 6 show a second embodiment of the rotary magnetic head drum apparatus in accordance with the present invention. FIG. 6 is an enlarged cross sectional view of a part of the locking screw 13a in a cross sectional view shown in FIG. 5. The same reference numerals are attached to the common portions to those in FIGS. 1 to 3.

FIG. 5 shows a structure in which a motor stator 12d is fastened together with the upper fixed drum 4 at a time of fastening the upper fixed drum 4 to the preload metal fitting 5. FIG. 6 is a partly cross sectional view of the locking screw 13a in the embodiment shown in FIG. 5, and shows with exaggeration a motion of the upper fixed drum 4 in the case of increasing the screwing amount of the locking screw 13a. The state before adjustment is shown by a solid line, and the upper fixed drum 4b after adjustment is shown by a two-dot chain line.

In the second embodiment, the structure is made such that the motor stator 12d is fastened together. Since the motor stator 12d is pressed and fixed to the preload metal fitting 5, the slope is not changed even by adjusting the upper fixed drum 4 by the locking screw 13a. Accordingly, a positional relation among the motor rotor 12a, the motor stator 12d and the motor coil 12b is not changed, and a performance of the motor is not affected at all.

### Embodiment 3

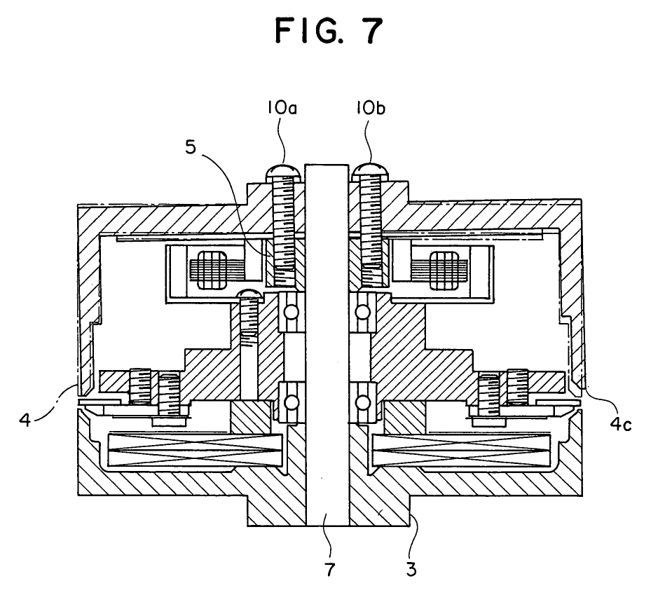

FIG. 7 shows a third embodiment of the rotary magnetic head drum apparatus in accordance with the present invention, and corresponds to a cross sectional view along a line X-X in FIG. 2.

FIG. 7 shows a preferable positional relation between the upper fixed drum and the outer peripheral surface of the lower fixed drum. In other words, in the input side of the tape, the outer periphery of the lower end portion of the upper fixed drum is slightly (0.001 mm to 0.005 mm) moved backward with respect to the outer periphery of the lower fixed drum, and in the output side of the tape, the outer periphery of the lower end portion of the upper fixed drum is slightly protruded with respect to the outer periphery of the lower fixed drum. In FIG. 7, the above structure is shown with exaggeration, the state before adjustment (the outer peripheral surfaces of the upper and lower drums are at the same height position) is shown by a one-dot chain line, and an upper fixed drum 4c after adjustment is shown by a solid line. Under this state, the contact pressure between the magnetic tape and the magnetic head is uniformized, and an improved output waveform can be obtained.

This means that a tape tension in the output side is increased due to a friction with respect to a tape tension in the input side of the magnetic tape, and the tape tension is not uniform. The outer periphery of the lower end portion of the upper fixed drum in the input side is slightly moved backward from the outer periphery of the lower end portion of upper fixed drum in the output side with respect to the outer periphery of the lower fixed drum, whereby the difference in the tape pressure applied to the magnetic head between the input side time and the output side time is reduced, the contact between the magnetic tape and the magnetic head is stabilized and the improved output waveform can be obtained.

Each of the embodiments mentioned above only corresponds to one embodiment in accordance with the present invention, and the number and the arrangement of the adjusting screws (the male screws 10a and 10b and the locking screws 13a and 13b) are not limited to this. Further, in the magnetic recording apparatus employing the rotary magnetic head drum apparatus mentioned above, the contact between the magnetic tape and the magnetic head is stable, and the improved output waveform can be obtained.

As mentioned above, in accordance with the present invention, it is possible to provide the rotary magnetic head drum apparatus and the magnetic recording and reproducing apparatus which can obtain the improved output signal.

The invention may be embodied in other specific forms without departing from the spirit or essential characteristics thereof. The present embodiment is therefore to be considered in all respects as illustrative and not restrictive, the scope of the invention being indicated by the appended claims rather than by the forgoing description and range of equivalency of the claims are therefore intended to be embraced therein.

1. A rotary magnetic head drum apparatus in which a shaft is pressure inserted and fixed to a lower fixed drum having a lead for guiding a travel motion of a magnetic tape, an upper fixed drum is arranged in a free end side of said shaft, a rotatably center rotating drum mounting a magnetic head between said lower fixed drum and said upper fixed drum is provided on the same axis as that of said lower fixed drum, and a magnetic tape is capable of traveling along said lead,
wherein a preload metal fitting for applying a preload to a bearing supping said center rotating drum is fixed to a free end side of said shaft,
wherein said upper fixed drum is provided with a hole fitted to said shaft at a position concentrically arranged with an outer periphery of said upper fixed drum in an end surface portion of an upper portion of said upper fixed drum so as to pass said shaft therethrough, and is mounted to a free end side of said preload metal fitting, and
wherein an adjuster for adjusting an attitude of said upper fixed drum with respect to said lower fixed drum so as to fix to said shaft is provided in the end surface portion of the upper portion of said upper fixed drum.

2. A rotary magnetic head drum apparatus as claimed in claim 1, wherein said adjuster is provided with a female thread in said preload metal fitting, is provided with a screw inserting hole in the end surface portion of the upper portion of said upper fixed drum, and is structured such that said upper fixed drum is fixed to said preload metal fitting by adjusting a fastening torque by a male screw.

3. A rotary magnetic head drum apparatus as claimed in claim 2, wherein said adjuster is fixed via a spring washer at a time of fixing said upper fixed drum to said preload metal fitting by said male screw.

4. A rotary magnetic head drum apparatus as claimed in claim 2, wherein said adjuster is further provided with a penetrating female thread in the end surface portion of the upper portion of said upper fixed drum at a position which is different from said screw inserting hole, and is structured such as to fix said upper fixed drum by screwing a locking screw to said female screw and adjusting the screwing amount.

5. A rotary magnetic head drum apparatus as claimed in claim 4, wherein said adjuster is fixed via a spring washer at a time of fixing said upper fixed drum to said preload metal fitting by said male screw.

6. A rotary magnetic head drum apparatus as claimed in claim 2, wherein said adjuster is provided with said male screw or said locking screw for adjusting in angular phase positions in correspondence to both end positions of a contact area between said magnetic tape and said magnetic head.

7. A rotary magnetic head drum apparatus as claimed in claim 1, wherein the outer periphery of the lower end portion of said upper fixed drum is moved backward to an inner side with respect to the outer periphery of said lower fixed drum at a micro amount, at a position in an input side where said magnetic tape moves forward to said apparatus, and the outer periphery of the lower end portion of said upper fixed drum is protruded to an outer side with respect to the outer periphery of said lower fixed drum at a micro amount, at a position in an output side of the magnetic tape where said magnetic tape is moved backward from said apparatus.

8. A rotary magnetic head drum apparatus in which a lower fixed drum, an upper fixed drum and a center rotating drum pinched therebetween and mounting a magnetic head thereon are coaxially mounted to a fixed shaft,
wherein an adjuster for adjusting an attitude of said upper fixed drum with respect to said lower fixed drum and said center rotating drum is provided in an end surface portion of an upper portion in said upper fixed drum.

9. A method of manufacturing a rotary magnetic head drum apparatus in which a shaft is pressure inserted and fixed to a lower fixed drum having a lead for guiding a travel motion of a magnetic tape, an upper fixed drum is arranged in a free end side of said shaft, a rotatably center rotating drum mounting a magnetic head between said lower fixed drum and said upper fixed drum is provided on the same axis as that of said lower fixed drum, and a magnetic tape travels along said lead, comprising the steps of:
fixing a preload metal fitting for applying a preload to a bearing supping said center rotating drum to a free end side of said shaft;
arranging said upper fixed drum a hole fitted to said shaft at a position concentrically arranged with an outer periphery of said upper fixed drum in an end surface portion of an upper portion of said upper fixed drum so as to pass said shaft therethrough;
mounting said upper fixed drum to a free end side of said preload metal fitting; and
adjusting an attitude of said upper fixed drum with respect to said lower fixed drum so as to fix to said shaft, by an adjuster provided in the end surface portion of the upper portion of said upper fixed drum.

10. A magnetic recording and reproducing apparatus for recording and reproducing a digital signal with respect to the magnetic tape by the rotary magnetic head drum apparatus as claimed in claim 1.
